(19) United States
(12) Patent Application Publication
(10) Pub. No.: US 2019/0349734 A1
(43) Pub. Date: Nov. 14, 2019

(54) Narrowband Communication System With A Standalone Carrier

(71) Applicant: Telefonaktiebolaget LM Ericsson (publ), Stockholm (SE)

(72) Inventors: Yutao Sui, Solna (SE); Niklas Johansson, Uppsala (SE); Lichen Wang, Beijing (CN); Yi-Pin Eric Wang, Fremont, CA (US)

(21) Appl. No.: 16/305,440

(22) PCT Filed: Jun. 13, 2017
(86) PCT No.: PCT/SE2017/050630

§ 371 Date: Nov. 29, 2018

Related U.S. Application Data
(60) Provisional application No. 62/352,324, filed on Jun. 20, 2016.

(51) Int. Cl. H04W 4/80; H04W 72/04; H04L 27/26; H04W 68/00

(52) U.S. Cl. CPC H04W 4/80; H04W 68/005; H04L 27/2607; H04W 72/0453

(57) ABSTRACT

Some embodiments disclosed here provide a method performed by a radio node in a narrowband communication system. The method comprises deploying a standalone narrowband carrier for the narrowband communication system outside of an in-band and a guardband of a wideband carrier for a wideband communication system. The method further comprises transmitting deployment information to a wireless device indicating that the standalone narrowband carrier is deployed in the in-band or the guardband of the wideband carrier.

### BACKGROUND

Cellular communication systems are currently being developed and improved for machine type communication (MTC), communication characterized by lower demands on data rates than for example mobile broadband, but with higher requirements on e.g. low cost device design, better coverage, and ability to operate for years on batteries without charging or replacing the batteries. Currently, 3GPP is standardizing a feature called Narrowband Internet of Things (NB-IoT) for satisfying all the requirements put forward by MTC type applications, while maintaining backward compatibility with the current LTE radio access technology. At 3GPP RAN#70 meeting, a new work item named Narrowband IoT (NB-IoT) was approved, see. The objective is to specify a radio access for cellular internet of things that addresses improved indoor coverage, support for massive number of low throughput devices, low delay sensitivity, ultra-low device cost, low device power consumption and (optimized) network architecture.

For NB-IoT, three different operation modes are defended, i.e., stand-alone, guard-band, and in-band. In stand-alone mode, the NB-IoT system is operated in dedicated frequency bands. For in-band operation, the NB-IoT system can be placed inside the frequency bands used by the current LTE system, while in the guard-band mode, the NB-IoT system can be placed in the guard band used by the current LTE system. The NB-IoT can operate with a system bandwidth of 180 kHz. When multi-PRBs are configured, e.g., as described in [7], several 180 kHz PRBs can be used, e.g., for increasing the system capacity, inter-cell interference coordination, load balancing etc.

In the current multi-PRB (or multi-carrier) support of NB-IoT, the following agreement are made as described in [7].
Any combination, i.e., inband+inband, inband+guardband, and guardband+guardband should be allowed for NB-IoT multi-carrier operation with the constraint that both guard-bands and the in-band are associated with the same LTE donor cell, i.e., the total span cannot exceed 110 PRBs from the same FFT.
No support of NB-IoT multi-carrier operation for standalone mode with either guard-band or in-band mode of operation
Standalone+standalone should be allowed for NB-IoT multi-carrier operation with the constraint that the total frequency span cannot exceed 20 MHz and both NB-IoT carriers are synchronized, i.e., the time alignment error shall not exceed the minimum requirement for intra-band contiguous carrier aggregation in TS 36.104

From the agreement, it can be seen that for standalone multi carrier case, for NB-IoT multi-carrier (multi-PRB) operation, it is not possible for it to work with other operation modes other than standalone mode.

### SUMMARY

One or more embodiments herein deploy a standalone narrowband carrier (e.g., a standalone NB-IoT carrier), yet signal that the standalone narrowband carrier is an in-band or guardband narrowband carrier deployed respectively in the in-band or guardband of a wideband carrier. In one embodiment, the standalone narrowband carrier is deployed at a frequency position imposed on or otherwise consistent with that of an in-band or guardband carrier. In this and other embodiments, therefore, the standalone narrowband carrier may appear to a wireless device as being an in-band or guardband carrier, even though it is actually a standalone carrier. In some embodiments, this advantageously facilitates multi-carrier operation using both the standalone narrowband carrier and an in-band or guardband narrowband carrier.

More generally, embodiments herein include a method performed by a radio node (e.g., a base station) in a narrowband communication system (e.g., an NB-IoT system). The method comprises deploying a standalone narrowband carrier for the narrowband communication system outside of an in-band and a guardband of a wideband carrier for a wideband communication system (e.g., an LTE system). The method also comprises transmitting deployment information to a wireless device (e.g., a user equipment) indicating that the standalone narrowband carrier is deployed in the in-band or the guardband of the wideband carrier.

In some embodiments, the deploying comprises deploying the standalone narrowband carrier at a frequency position that satisfies a channel raster condition imposed on a narrowband carrier deployed in the in-band or the guardband of the wideband carrier. In one embodiment, for example, the channel raster condition is that a narrowband carrier deployed in the in-band or the guardband of the wideband carrier must be offset from a 100 kHz channel raster by +/−2.5 kHz or +/−7.5 kHz.

In some embodiments, one or more other communication systems are deployed at a frequency position between the standalone narrowband carrier and the wideband carrier. Alternatively, no communication systems are deployed at a frequency position between the standalone narrowband carrier and the wideband carrier.

In some embodiments, the standalone narrowband carrier may be an anchor carrier for multi-carrier operation, whereas in other embodiments the standalone narrowband carrier may be a non-anchor carrier for multi-carrier operation. In one embodiment, for example, the method further comprises deploying one or more other narrowband carriers for the narrowband communication system in the in-band or the guardband of the wideband carrier. In this case, the standalone narrowband carrier may be deployed as an anchor carrier and the one or more other narrowband carriers may be deployed as one or more non-anchor carriers. The anchor carrier and the one or more non-anchor carriers may be configured for multi-carrier operation, one carrier at a time, by a wireless device.

In another embodiment, the method alternatively may comprise deploying another narrowband carrier for the narrowband communication system as an anchor carrier in the in-band or the guardband of the wideband carrier and deploying the standalone narrowband carrier as a non-anchor carrier. The anchor carrier and the non-anchor carrier may be configured for multi-carrier operation, one carrier at a time, by a wireless device.

Regardless of which carrier is the anchor and non-anchor carrier, the anchor carrier and non-anchor carrier may be downlink carriers. Note that in some embodiments, an anchor carrier is a carrier on which broadcast transmissions are made, and a non-anchor carrier is a carrier on which unicast transmissions, not broadcast transmissions, are made. Alternatively or additionally, an anchor carrier is a carrier on which system information is broadcasted and a non-anchor carrier is a carrier on which no system information is broadcasted. Alternatively or additionally, an anchor carrier is a carrier on which paging information is broadcasted and a non-anchor carrier is a carrier on which no paging information is broadcasted. Alternatively or additionally, an anchor carrier is a carrier on which a synchronization signal is broadcasted and a non-anchor carrier is a carrier on which no synchronization signal is broadcasted.

In other embodiments, by contrast, the anchor and non-anchor carriers are uplink carriers.

In still other embodiments, the deploying comprises dynamically deploying the standalone narrowband carrier as needed based on traffic demand. In this case, dynamically deploying may comprise adjusting a frequency position of the narrowband carrier, changing a deployment mode of the narrowband carrier, changing channel raster information broadcasted for the narrowband communication system, and/or changing broadcasted system information indicating a frequency position of the narrowband carrier.

In any of the above embodiments, the radio node may be a base station and the wireless device may be a user equipment.

In any of the above embodiments, the wideband communication system may be a Long Term Evolution (LTE) system and the narrowband communication system may be a Narrowband Internet of Things (NB-IoT) system.

Embodiments herein also include a corresponding method performed by a wireless device in a narrowband communication system. The method comprises receiving deployment information from a radio node indicating that a standalone narrowband carrier for the narrowband communication system is deployed in an in-band or a guardband of a wideband carrier for a wideband communication system. The method also comprises transmitting or receiving on the standalone narrowband carrier outside of the in-band and the guardband of the wideband carrier.

Embodiments also include corresponding apparatus, computer programs, and carriers (e.g., computer program products stored on non-transitory computer readable mediums).

In one or more particular embodiments, the standalone NB-IoT carrier is virtualized to make it work together with inband or guardband NB-IoT carriers.

### BRIEF DESCRIPTION OF DRAWINGS

FIG. 1 illustrates a network 100 wherein embodiments herein may be employed.

FIG. 2A illustrates an example, where a legacy carrier (e.g., GSM carrier) is interposed in frequency between a wideband carrier and a narrowband carrier.

FIG. 2B illustrates an example where a standalone narrowband carrier is signaled as being deployed in-band of a wideband carrier even though in actuality it is deployed as a standalone carrier as shown in FIG. 2A.

FIG. 3 illustrates a method performed by a radio node according to some embodiments herein.

FIG. 4 illustrates a method performed by a wireless device according to some embodiments herein.

FIG. 5 illustrates a radio node 12 implemented in the form of a radio node 12A in accordance with one or more embodiments.

FIG. 6 illustrates a radio node 12 implemented in the form of a radio node 12B in accordance with one or more other embodiments.

FIG. 7 illustrates a wireless device 14 implemented in the form of a wireless device 14A in accordance with one or more embodiments.

FIG. 8 illustrates a wireless device 14 implemented in the form of a wireless device 14B in accordance with one or more other embodiments.

FIG. 9 illustrates center frequency offset of LTE PRBs for even and odd system bandwidths

FIG. 10 illustrates an example when an anchor PRB is inband and a secondary PRB is inband.

FIG. 11 illustrates an example when an anchor PRB is inband and a secondary PRB is in guardband

FIG. 12 illustrates an example when an anchor PRB is guardband, secondary PRB is inband.

FIG. 13 illustrates an example of a re-farming scenario.

FIG. 14 illustrates an example when an anchor carrier is standalone and secondary carriers are other standalone carriers.

FIG. 15 illustrates an example of a virtualized LTE system that includes the NB-IoT carrier at the band edge as inband mode.

FIG. 16 illustrates an example of a virtualized LTE system that includes the NB-IoT carrier at the band edge as guardband mode.

FIG. 17 illustrates an example of a virtualized LTE system that includes the NB-IoT carrier in between two legacy carriers as inband mode.

FIGS. 18 and 19 illustrate examples of a virtualized LTE system where the NB-IoT carrier is deployed between an LTE carrier (e.g. outside the guardband of the LTE) and other system.

### DETAILED DESCRIPTION

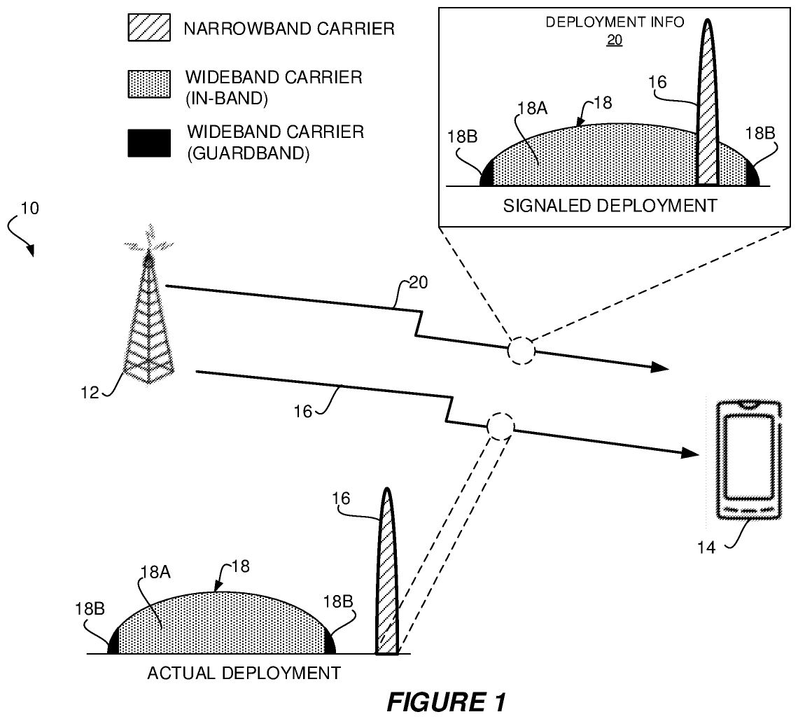

FIG. 1 shows a narrowband communication system 10 (e.g., an NB-IoT system) according to one or more embodiments. The system 10 includes a radio node 12 (e.g., a base station) and a wireless device 14 (e.g., a user equipment). The radio node 12 is configured to deploy a standalone narrowband carrier 16 for the narrowband communication system 10. Although shown in FIG. 1 as being a downlink carrier, carrier 16 may alternatively be an uplink carrier. In any event, the standalone narrowband carrier 16 is “standalone” in the sense that it is deployed outside of an in-band 18A and a guardband 18B of a wideband carrier 18 for a wideband communication system (e.g., an LTE system). That is, the standalone narrowband carrier 16 is positioned in the frequency domain outside of the wideband carrier's channel bandwidth (which includes the wideband carrier's actual transmission bandwidth as well as its guard band), so as to stand alone apart from the wideband carrier.

The radio node 12 also transmits deployment information 20 to the wireless device 14, e.g., by broadcasting the information 20 via system information. The deployment information 20 includes information about the deployment of the narrowband carrier 16. Even though the radio node 12 deploys the standalone narrowband carrier 16 outside of the wideband carrier's in-band 18A and guardband 18B, the radio node 12 nonetheless transmits the deployment information 20 to indicate that the standalone narrowband carrier 16 is deployed in the in-band 18A or guardband 18B of the wideband carrier 18. FIG. 1 for examples shows that the radio node 12 transmits the deployment information 20 to indicate that the standalone narrowband carrier 16 is deployed in the in-band 18A of the wideband carrier 18.

Indicating to the wireless device 14 that the standalone narrowband carrier 16 is deployed in the wideband carrier's in-band 18A or guardband 18B, even though it is not actually deployed in that way, means that the standalone narrowband carrier 16 may in some embodiments appear to the wireless device 14 as an in-band or guardband narrowband carrier, even though it is not. That is, the wireless device 14 may be naïve as to the true nature of the standalone narrowband carrier's deployment, i.e., the standalone narrowband carrier is “disguised” to the wireless device 14 as an in-band or guardband carrier. In other embodiments, however, the wireless device 14 knows the true nature of the standalone narrowband carrier's deployment, but treats the standalone narrowband carrier 16 as an in-band or guardband carrier, even though it is not, in accordance with the deployment information 20.

In any case, one or more embodiments herein may in some sense “disguise” or “virtualize” the standalone narrowband carrier 16 as an in-band or guardband narrowband carrier. From another perspective, embodiments herein may “disguise” or “virtualize” the wideband communication system as being a wideband system with a channel bandwidth that is larger than or shifted with respect to its actual channel bandwidth, such that the wideband system's channel bandwidth overlaps the narrowband carrier's bandwidth.

In fact, in some embodiments, the radio node 12 may deploy the standalone narrowband carrier 16 at a frequency position imposed on or otherwise consistent with that of an in-band or guardband carrier. In some embodiments where the standalone narrowband carrier 16 is a downlink carrier, for instance, the radio node 12 may deploy the standalone narrowband carrier 16 at a frequency position that satisfies a channel raster condition imposed on a narrowband carrier deployed in the in-band or the guardband of the wideband carrier 18. In one embodiment, for example, any in-band or guardband narrowband carrier must be positioned in frequency at one of multiple candidate positions defined with respect to a channel raster, e.g., positions offset from a 100 kHz channel raster by +/−2.5 kHz or +/−7.5 kHz. In this case, the radio node 12 deploys the standalone narrowband carrier 16 at one of these multiple candidate positions, e.g., even though no such requirement exists of the standalone narrowband carrier 16 due to its standalone deployment nature.

In other embodiments where the standalone narrowband carrier 16 is an uplink carrier, the carrier 16 may be deployed at a certain frequency duplex distance from a downlink narrowband carrier deployed for the system 10. This certain frequency duplex distance may be a distance imposed on uplink carriers deployed inside the wideband carrier's in-band or guardband.

No matter whether the standalone narrowband carrier 16 is an uplink or downlink carrier, therefore, its frequency position, especially in conjunction with the deployment information 20, thereby suggests to the wireless device 14 that the carrier 16 is deployed as an in-band or guardband carrier, despite its true deployment as a standalone carrier. This proves especially true in some embodiments where the wireless device 14 is configured to search for an in-band or guardband narrowband carrier only at the multiple candidate positions (i.e., had the standalone narrowband carrier 16 been deployed at another position it would not be discoverable as an in-band or guardband carrier by the wireless device 14).

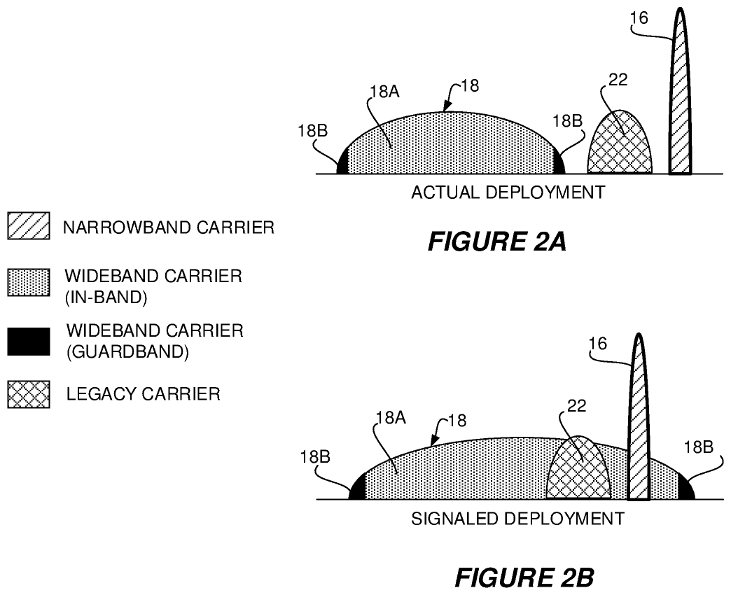

In some embodiments, the radio node 12 deploys the standalone narrowband carrier 16 in this way in order to utilize certain frequency spectrum for a narrowband carrier. Some frequency spectrum may for instance be too narrow for deploying a wideband communication system; because the wideband carrier cannot be deployed in that spectrum, neither can a narrowband carrier 16 be deployed as in-band or guardband carrier in that spectrum. In other embodiments, Alternatively or additionally, some frequency spectrum may be divorced from the wideband communication system by one or more other “intervening” communication systems deployed at a frequency position between the narrowband communication system 10 and that wideband communication system. FIG. 2A illustrates such a case, where a legacy carrier 22 (e.g., GSM carrier) is interposed in frequency between the wideband carrier 18 and the narrowband carrier 16. If the radio node 12 is to utilize this spectrum for a narrowband carrier, the radio node 12 has to deploy that carrier as a standalone carrier apart from the wideband carrier 18. According to embodiments herein, by contrast, the radio node 12 may deploy the narrowband carrier 16 as a standalone carrier yet indicate that it is an in-band or guardband carrier. As shown in FIG. 2B, for instance, the standalone narrowband carrier 16 is signaled as being deployed in-band of the wideband carrier 16, even though in actuality it is deployed as a standalone carrier as shown in FIG. 2A.

The radio node 12 may deploy the standalone carrier 16 in this way to not only utilize certain frequency spectrum but also to realize certain benefits of in-band and guardband deployments. For example, in some embodiments, the radio node 12 and/or wireless device 14 are configured for multi-carrier operation. According to this operation, the radio node 12 and/or the wireless device 14 may operate on multiple narrowband carriers, one at a time. For example, in some embodiments, the wireless device 14 may initially operate on a so-called anchor carrier (e.g., containing broadcast transmissions, system information, paging information, and/or a synchronization signal, in the downlink case). The wireless device 14 may thereafter switch to operating on a non-anchor carrier (e.g., containing user data or other unicast transmissions, but no broadcast transmissions, system information, paging information, and/or synchronization signals, in the downlink case). The wireless device 14 may make this switch for example upon radio resource control (RRC) connection. However, the multiple carriers on which the radio node 12 and/or the wireless device 14 are configured to operate may be nominally limited to in-band and guardband carriers. Yet embodiments herein may “disguise” or “virtualize” a standalone narrowband carrier as being an in-band or guardband carrier, such that multi-carrier operation may use the standalone narrowband carrier 16 despite its true standalone deployment nature.

According to some embodiments, for example, the radio node 12 (or some other radio node not shown) deploys one or more other narrowband carriers in the in-band 18A or guardband 18B of the wideband carrier 18. In this case, the standalone narrowband carrier 16 may be deployed as an anchor carrier and the one or more other narrowband carriers may be deployed as one or more non-anchor carriers. According to embodiments herein, the standalone narrowband carrier 16 as an anchor carrier may be used for multi-carrier operation, one carrier at a time, with the one or more other narrowband carriers as one or more non-anchor carriers.

Alternatively, the radio node 12 (or some other radio node) may deploy another narrowband carrier as an anchor carrier in the in-band 18A or the guardband 18B of the wideband carrier 18, and deploy the standalone narrowband carrier 16 as a non-anchor carrier. According to embodiments herein, the standalone narrowband carrier 16 as a non-anchor carrier may be used for multi-carrier operation, one carrier at a time, with the other narrowband carriers as an anchor carrier.

No matter whether the standalone narrowband carrier 16 is used as an anchor or non-anchor carrier, though, at least some embodiments advantageously facilitate the radio node 12 deploying the standalone narrowband carrier 16 in that capacity on a dynamic basis, e.g., as needed based on traffic demand. The radio node 12 may for instance selectively advertise or otherwise signal the standalone narrowband carrier 16 as being an in-band or guardband carrier, when one or more conditions are met suggesting that multi-carrier operation would be advantageous (e.g., traffic demand reaches a threshold). Alternatively or additionally, such dynamic deployment of the standalone narrowband carrier 16 may involve adjusting a frequency position of the carrier 16, changing a deployment mode of the carrier 16, changing channel raster information broadcast from the narrowband system 10, and/or changing broadcasted system information indicating a frequency position of the carrier 16.

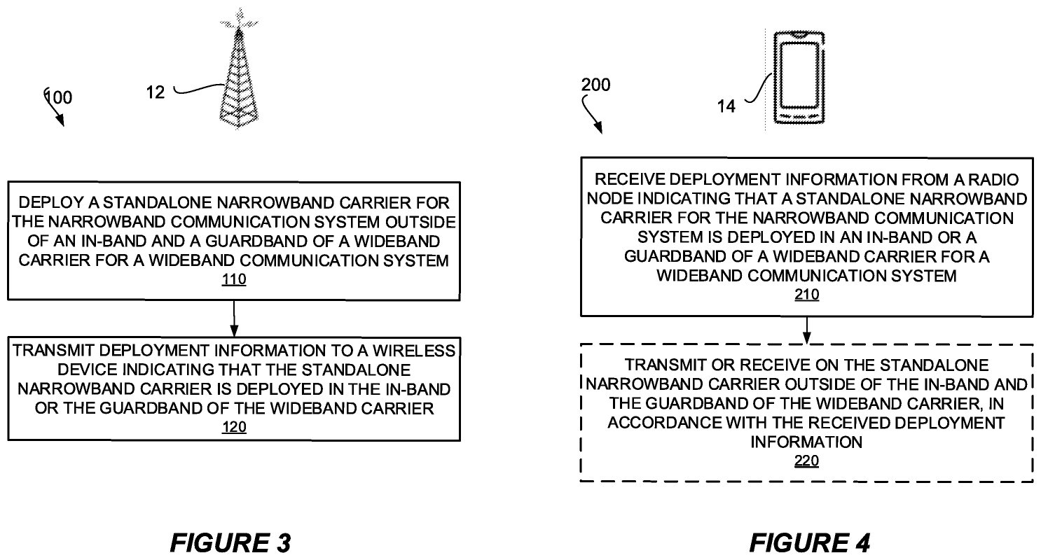

In view of the above modifications and variations, FIG. 3 illustrates a method performed by a radio node 12 according to some embodiments herein. As shown, the method 100 may comprise deploying a standalone narrowband carrier 16 for the narrowband communication system 10 outside of an in-band 18A and a guardband 18B of a wideband carrier 18 for a wideband communication system (Block 110). The method 100 also may comprise transmitting deployment information 20 to a wireless device 14 indicating that the standalone narrowband carrier 16 is deployed in the in-band 18A or the guardband 18B of the wideband carrier 18 (Block 120).

FIG. 4 illustrates a corresponding method performed by a wireless device 14 according to some embodiments. The method 200 comprises receiving deployment information 20 from a radio node 12 indicating that a standalone narrowband carrier 16 for the narrowband communication system 10 is deployed in an in-band 18A or a guardband 18B of a wideband carrier 18 for a wideband communication system (Block 210). The method 200 may also comprise transmitting or receiving on the standalone narrowband carrier 16 outside of the in-band 18A and the guardband 18B of the wideband carrier 18, in accordance with the received deployment information 20 (Block 220).

Note that the radio node 12 (e.g., base station) as described above may perform any of the processing herein by implementing any functional means or units. In one embodiment, for example, the radio node 12 comprises respective circuits or circuitry configured to perform the steps shown in FIG. 3. The circuits or circuitry in this regard may comprise circuits dedicated to performing certain functional processing and/or one or more microprocessors in conjunction with memory. In embodiments that employ memory, which may comprise one or several types of memory such as read-only memory (ROM), random-access memory, cache memory, flash memory devices, optical storage devices, etc., the memory stores program code that, when executed by the one or more processors, carries out the techniques described herein.

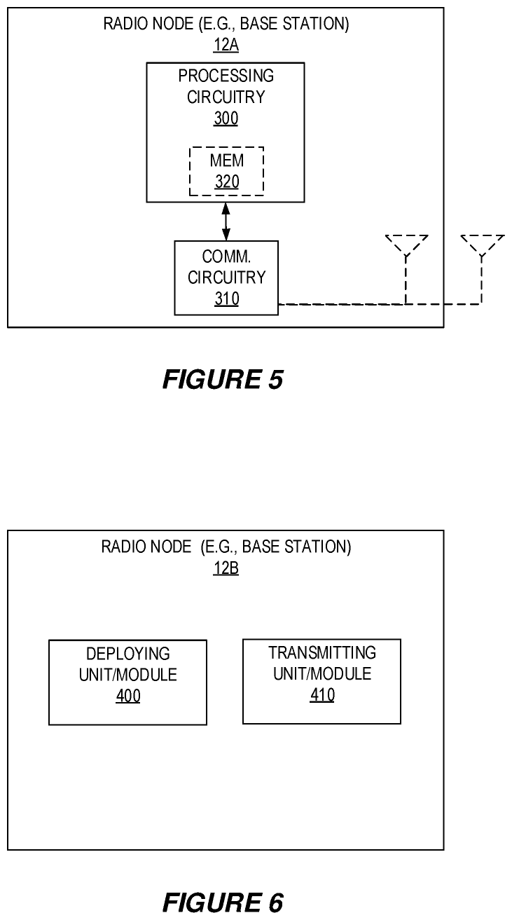

FIG. 5 illustrates a radio node 12 implemented in the form of a radio node 12A in accordance with one or more embodiments. As shown, the radio node 12A includes processing circuitry 300 and communication circuitry 310. The communication circuitry 310 is configured to transmit and/or receive information to and/or from one or more other nodes, e.g., via any communication technology. The communication circuitry 310 may do so for instance via one or more antennas, which may be internal or external to the radio node 12. The processing circuitry 300 is configured to perform processing described above, e.g., in FIG. 3, such as by executing instructions stored in memory 320. The processing circuitry 300 in this regard may implement certain functional means, units, or modules.

FIG. 6 illustrates a radio node 12 implemented in the form of a radio node 12B in accordance with one or more other embodiments. As shown, the radio node 12B implements various functional means, units, or modules, e.g., via the processing circuitry 300 in FIG. 5 and/or via software code. These functional means, units, or modules, e.g., for implementing the method in FIG. 3, include for instance a deploying unit or module 400 for deploying a standalone narrowband carrier 16 for the narrowband communication system 10 outside of an in-band 18A and a guardband 18B of a wideband carrier 18 for a wideband communication system. Also included may be a transmitting unit or module 410 for transmitting deployment information 20 to a wireless device 14 indicating that the standalone narrowband carrier 16 is deployed in the in-band 18A or the guardband 18B of the wideband carrier 18.

Similarly, a wireless device 14 as described above may perform any of the processing herein by implementing any functional means or units. In one embodiment, for example, the wireless device 14 comprises respective circuits or circuitry configured to perform the steps shown in FIG. 4. The circuits or circuitry in this regard may comprise circuits dedicated to performing certain functional processing and/or one or more microprocessors in conjunction with memory. In embodiments that employ memory, which may comprise one or several types of memory such as read-only memory (ROM), random-access memory, cache memory, flash memory devices, optical storage devices, etc., the memory stores program code that, when executed by the one or more processors, carries out the techniques described herein.

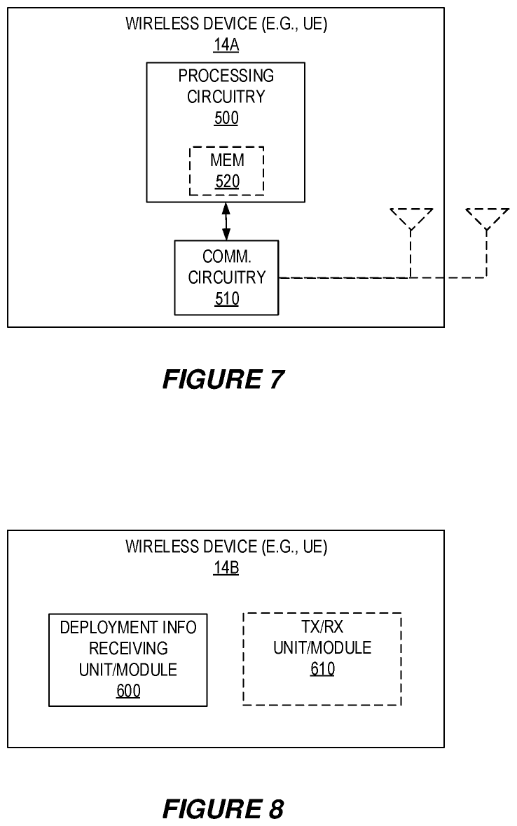

FIG. 7 illustrates a wireless device 14 implemented in the form of a wireless device 14A in accordance with one or more embodiments. As shown, the wireless device 14A includes processing circuitry 500 and communication circuitry 510. The communication circuitry 510 is configured to transmit and/or receive information to and/or from one or more other nodes, e.g., via any communication technology. The processing circuitry 500 is configured to perform processing described above, e.g., in FIG. 4, such as by executing instructions stored in memory 520. The processing circuitry 500 in this regard may implement certain functional means, units, or modules.

FIG. 8 illustrates a wireless device 14 implemented in the form of a wireless device 14B in accordance with one or more other embodiments. As shown, the wireless device 14B implements various functional means, units, or modules, e.g., via the processing circuitry 500 in FIG. 4 and/or via software code. These functional means, units, or modules, e.g., for implementing the method in FIG. 4, include for instance a deployment information receiving module 600 for receiving deployment information 20 from a radio node 12 indicating that a standalone narrowband carrier 16 for the narrowband communication system 10 is deployed in an in-band 18A or a guardband 18B of a wideband carrier 18 for a wideband communication system. Also included may be a transmitting or receiving module 610 for transmitting or receiving on the standalone narrowband carrier 16 outside of the in-band 18A and the guardband 18B of the wideband carrier 18, in accordance with the received deployment information 20.

Those skilled in the art will also appreciate that embodiments herein further include corresponding computer programs.

A computer program comprises instructions which, when executed on at least one processor of a radio node or wireless device, cause the radio node or wireless device to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of a radio node or wireless device, cause the network equipment or wireless device to perform as described above.

Embodiments further include a computer program product comprising program code portions for performing the steps of any of the embodiments herein when the computer program product is executed by a radio node or wireless device. This computer program product may be stored on a computer readable recording medium.

A radio node herein is any type of node (e.g., a base station, relay node, etc.) capable of communicating with another node over radio signals. A wireless device is any type of radio node capable of communicating with a radio network node over radio signals. A wireless communication device may therefore refer to a machine-to-machine (M2M) device, a machine-type communications (MTC) device, a NB-IoT device, etc. The wireless device may also be a user equipment (UE), however it should be noted that the UE does not necessarily have a “user” in the sense of an individual person owning and/or operating the device. A wireless device may also be referred to as a radio device, a radio communication device, a wireless terminal, or simply a terminal—unless the context indicates otherwise, the use of any of these terms is intended to include device-to-device UEs or devices, machine-type devices or devices capable of machine-to-machine communication, sensors equipped with a wireless device, wireless-enabled table computers, mobile terminals, smart phones, laptop-embedded equipped (LEE), laptop-mounted equipment (LME), USB dongles, wireless customer-premises equipment (CPE), etc. In the discussion herein, the terms machine-to-machine (M2M) device, machine-type communication (MTC) device, wireless sensor, and sensor may also be used. It should be understood that these devices may be UEs, but are generally configured to transmit and/or receive data without direct human interaction.

In an IOT scenario, a wireless communication device as described herein may be, or may be comprised in, a machine or device that performs monitoring or measurements, and transmits the results of such monitoring measurements to another device or a network. Particular examples of such machines are power meters, industrial machinery, or home or personal appliances, e.g. refrigerators, televisions, personal wearables such as watches etc. In other scenarios, a wireless communication device as described herein may be comprised in a vehicle and may perform monitoring and/or reporting of the vehicle's operational status or other functions associated with the vehicle.

Furthermore, in an NB-IoT context, it may be the case that, to support lower manufacturing costs for NB-IOT devices, the transmission bandwidth is reduced to one physical resource block (PRB) of size 180 KHz. Both frequency division duplexing (FDD) and TDD are supported. For FDD (i.e. the transmitter and receiver operate at different carrier frequencies) only half-duplex mode needs to be supported in the UE.

Despite particular applicability to NB-IoT in some examples, it will be appreciated that the techniques may be applied to other wireless networks, including eMTC as well as to successors of the E-UTRAN. Thus, references herein to signals using terminology from the 3GPP standards for LTE should be understood to apply more generally to signals having similar characteristics and/or purposes, in other networks.

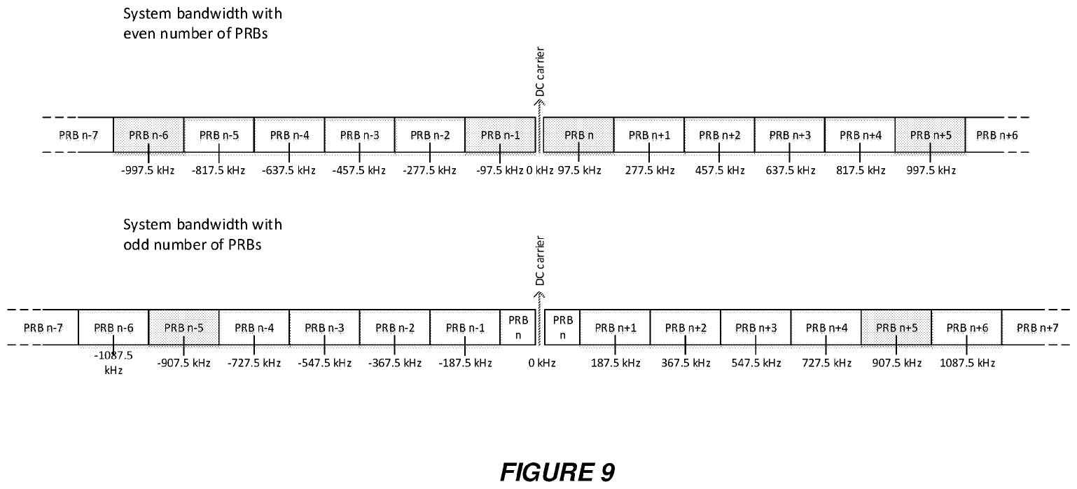

Nonetheless, for NB-IoT as the narrowband system 10 and LTE as the wideband system, the channel raster of the downlink of NB-IoT systems is on a frequency grid of 100 kHz. That is the NB-IoT devices try to find the NB-IoT carriers in a step size of 100 kHz. For the standalone deployment, this is fine. But for the in-band and guard-band operation, due to the presence of the DC-carrier and the fact the center of the physical resource block (PRB) is in between two sub-carriers, there is no PRB that falls directly on the cell search grid used in LTE in-band operation. The frequency offset to the 100 kHz grid is a minimum of ±2.5 kHz and ±7.5 kHz for even and odd number of PRBs in the LTE system bandwidth, respectively. This is shown in FIG. 9, and detailed description of this problem is given in [2] and [3]. The ±2.5 kHz or ±7.5 kHz can be handled by the device during the cell search process and then be compensated. See [4] and [5]. However, these offsets constrain the positions where NB-IoT carriers can be deployed for the in-band and guard-band operations. Therefore, for a NB-IoT DL carrier that contains synchronization signal and system information, it can only be put on a frequency that is near the 100 kHz grid point.

For the guard-band operation, as showed in [2] for an LTE system with 10 or 20 MHz system bandwidth, it is possible to find NB-IoT downlink carrier frequency that is 2.5 kHz off the 100 kHz frequency raster. For other LTE system bandwidth, the offset to the 100 kHz raster is 52.5 kHz. Therefore, in order to get within the same ±7.5 kHz to the 100 kHz grid, 3 guard subcarriers are needed. One guard carrier is 15 kHz width and placed in the same FFT grid at the legacy LTE system that gives orthogonality to the legacy LTE PRB. However, there are no other solutions to put the NB-IoT carriers on the exact 100 kHz raster grids on the LTE guard-band without losing orthogonality to the legacy LTE system.

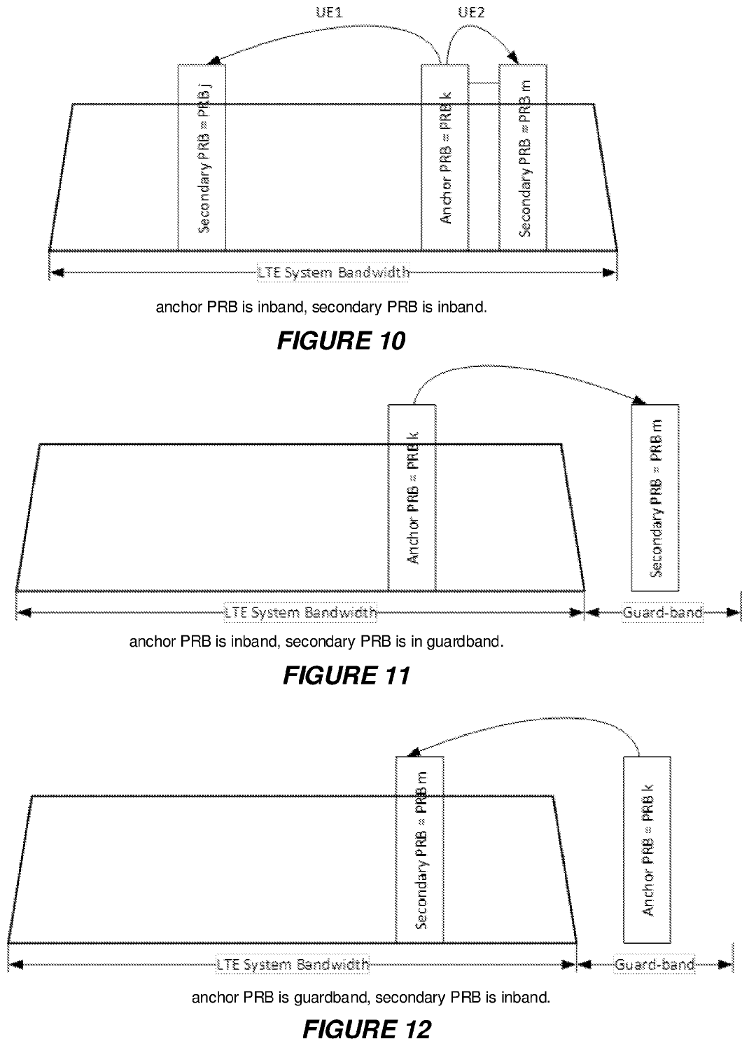

In order to adapt to certain use cases that requires more capacity than usual, e.g., software or firmware upgrade, multi-PRB operations are used [8]. The NB-IoT listens to the system information on the anchor PRB, but when there is data, the communication can be moved to a secondary PRB. Several multi-PRB configurations are shown in FIGS. 10, 11, and 12.

Based on the agreement in [8], “The UE in RRC_IDLE camps on the NB-IoT carrier on which the UE has received NB-PSS/SSS, NB-PBCH and SIB transmissions”, a DL Anchor PRB or carrier in this invention is defined as where the NB-PSS/SSS, NB-PBCH and SIB transmissions take place.

Based on the agreement in [8], “For initial access, the NB-IoT DL/UL frequency separation is configured by higher layers (SIBx) and is cell-specific”, and “After the initial random access procedure success, there can also be a UE specific configuration for the NB-IoT DL/UL frequency separation.”, a UL anchor PRB or carrier is defined as the UL frequency that is signaled to the NB-IoT device via higher layer signaling. Notice, based on the agreement in [8], the UL anchor PRB can be but not necessary different from the PRB where the initial random access takes place.

FIG. 9 illustrates the center frequency offsets of LTE PRBs from even and odd system bandwidths. The DC carrier is placed in between of two PRBs (even number of PRBs) or in the middle of the middle PRB (odd number cases). As discussed in [2] [3], if a 100 kHz raster is used, not all PRBs can be used for NB-IoT in-band deployment. For the guard-band operation, though the granularity does not need to be 1 PRBs, in order to maintain orthogonality to the legacy LTE system and limited the offset to ±2.5 kHz or ±7.5 kHz from 100 kHz raster grid, only several positions in the LTE guard-band can be used for the NB-IoT downlink anchor carriers [2]. In the evaluations in [4] and [5], ±2.5 kHz and ±7.5 kHz offset from the 100 kHz grid can be accommodated by the cell search process.

In order to achieve coverage requirement of the NB-IoT systems, compared to the average LTE data channel transmit power, a 6 dB power boosting is preferred for the downlink of the in-band and guard-band deployment [1]. The power boosting is with respect to the legacy data channel. But due to spectrum requirement, this 6 dB power boosting cannot be applied at arbitrary places in the guard band. To be more specific, it is stated in [1], that “Feasibility of boosting for transmission in the guard band depends on the system bandwidth, spacing between NB-IoT and LTE, and also the amount of boosting. When NB-IOT is not very close to the edge of the system bandwidth and with proper design of base station equipments, power boosting of up to 6 dB would be feasible.”

Certainly by increasing the number of repetitions, NB-IoT devices without good coverage can still be reached when the transmit power is not high enough. But this is at an expense of the system capacity. This can be very problematic when the network traffic is heavier than usual, e.g., for the case of software and firmware update. Therefore, multi-PRB operations are proposed in NB-IoT to help to alleviate the problem. When multi-PRB is configured, an NB-IoT listens to the anchor carrier for system information, but its data transmission can be moved to a secondary PRB. Several multi-PRB configurations are shown in FIGS. 10, 11, and 12.

As the secondary PRB position(s) can be sent to the NB-IoT devices explicitly, e.g., by RRC configuration or via system information, the positions of the secondary PRB are not constrained to near the 100 kHz grid. In this way, NB-IoT devices in good coverage can be moved to secondary PRBs with lower power, and NB-IoT devices in bad coverage can be served by PRBs with higher power boosting.

For the uplink operation, the deployment is more flexible, as it is not necessary to put the UL carrier in a position that is near the 100 kHz grid. That is the NB-IoT device can get the downlink and uplink carrier gap via system information (can be configured on an individual UE basis as described in [7]), if the default gap is not applied. Therefore, the placement of the uplink NB-IoT carrier has more flexibility. For the downlink operation, only 15 kHz subcarrier spacing is used for the NB-IoT system. But for the uplink, two different numerologies, i.e., 3.75 kHz and 15 kHz, of the uplink subcarrier spacing are defined in NB-IoT, for the single tone uplink transmission. For uplink with multi-tone transmission, only 15 kHz subcarrier spacing is used.

Certainly, it is preferred to deploy the uplink of the NB-IoT system on a 15 kHz FFT grid that is orthogonal to the legacy LTE system. This can ease the receiver design, since the guard-band signal can be received and processed together with the legacy LTE signal. However, as long as the interference between the NB-IoT system and the legacy LTE system is manageable, such a requirement can be relaxed, e.g., by using scheduling to lower the interference. Notice, that other methods are not precluded.

One common deployment situation is that an operator can re-farm its own frequency bands, e.g., change the frequency bands used for GSM/CDMA/WCDMA systems to LTE or NB-IoT standalone carriers. In such cases, some of the carriers of the systems will be shut down and used for new systems. But in order still to provide service to legacy users, some of the carriers of the legacy system will remain their services.

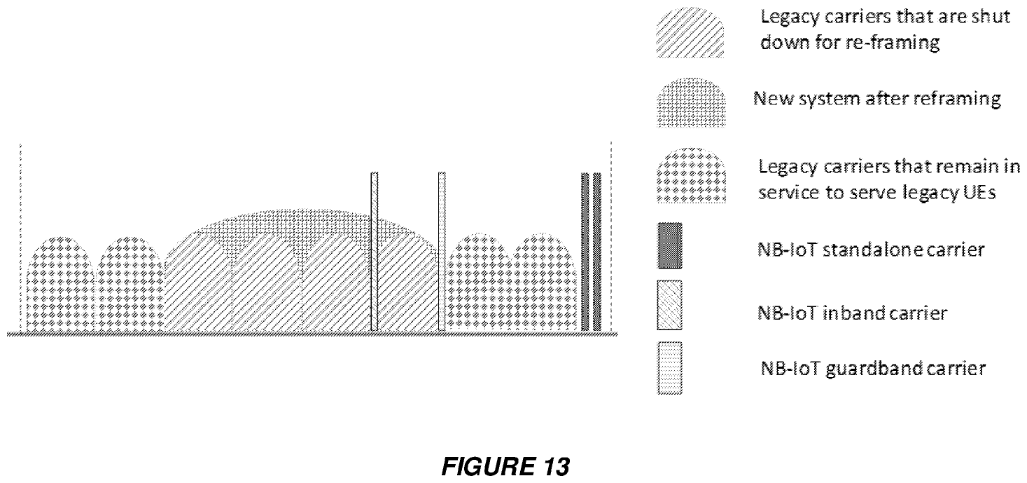

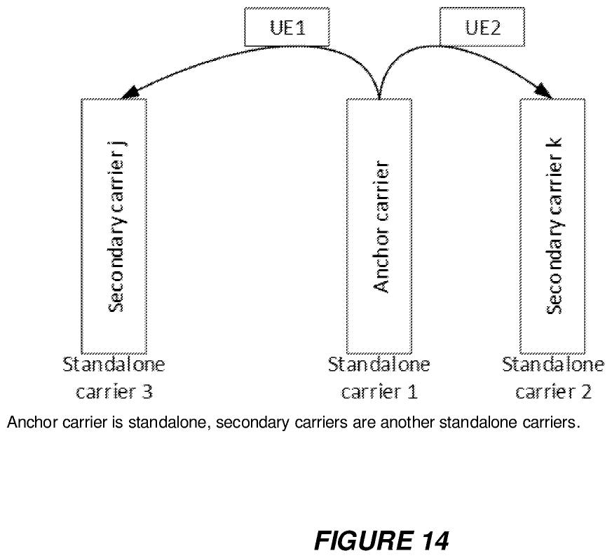

One example is given in FIG. 13. In this example, several narrower carriers are shut down and the bandwidth is used for a wideband system. One problem after refarm is that some small pieces of spectrum may be left unused, e.g., at the band edge(s). One way to use these small pieces of spectrum is to deploy NB-IoT system(s), which only require 200 kHz for standalone operation. This is an efficient way to use the fragmented spectrum. However, the limitation here is that it is difficult to expand the NB-IoT system(s) in the future. Indeed, as discussed above and as shown in FIG. 14, the multi-carrier operation of NB-IoT standalone carrier only works with another NB-IoT standalone carrier. Accordingly, it is heretofore not possible to further expand the NB-IoT standalone carriers to work with inband or guardband.

In order to have flexible deployment of the NB-IoT system, one or more embodiments herein virtualize the standalone NB-IoT carrier to inband or guardband mode. In this way, a standalone NB-IoT carrier can work with the inband or guardband carrier in the neighboring LTE system.

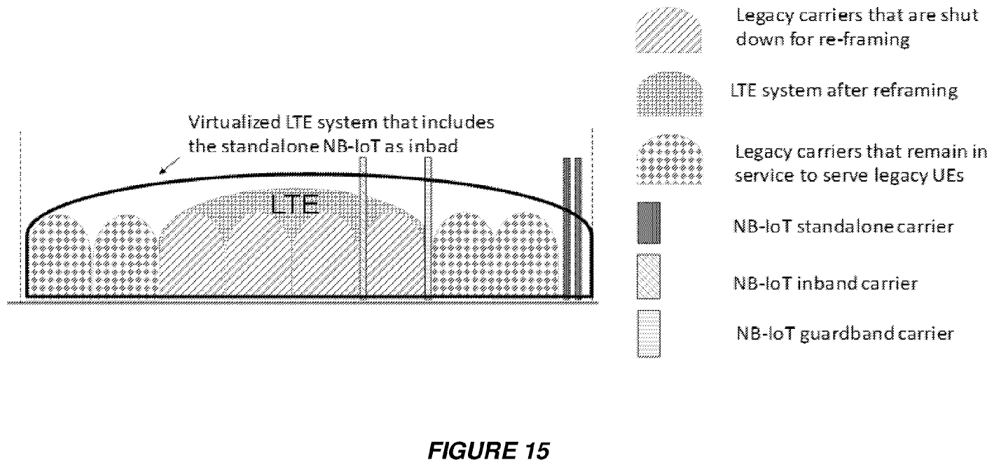

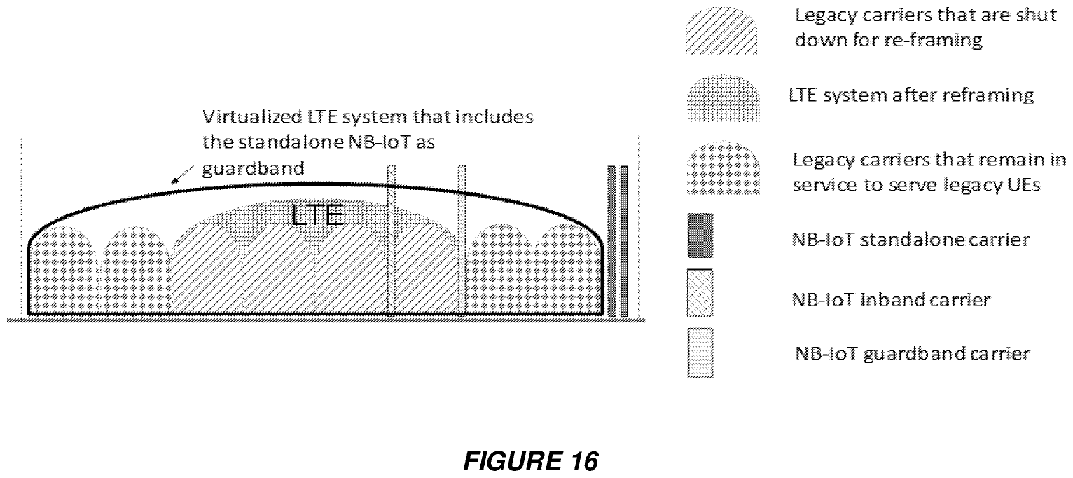

FIG. 15 and FIG. 16 illustrate one or more such embodiments. As can be seen from the figures, the NB-IoT carrier(s) are configured as inband or guardband of a virtualized LTE system with larger bandwidth than the actual deployed LTE system. In this way, the NB-IoT carrier(s) can identify itself as inband mode or guardband mode, and enable the multi-carrier operation with PRBs in the actual deployed LTE system.

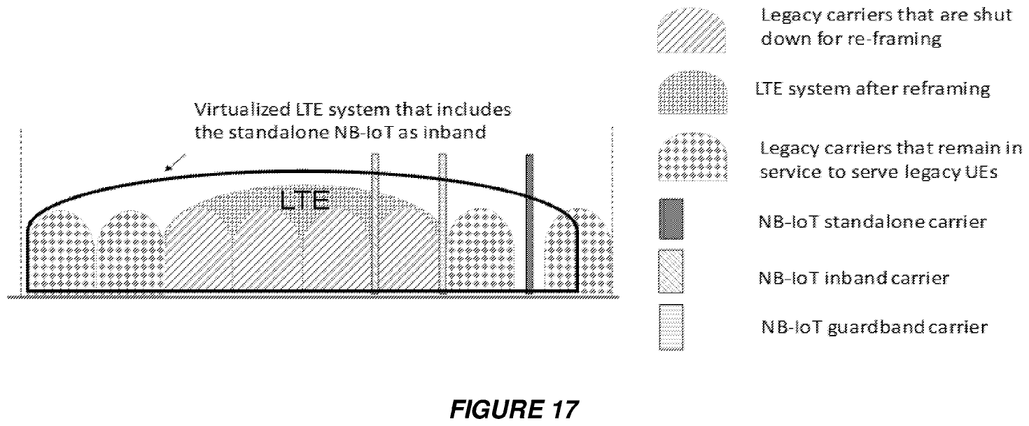

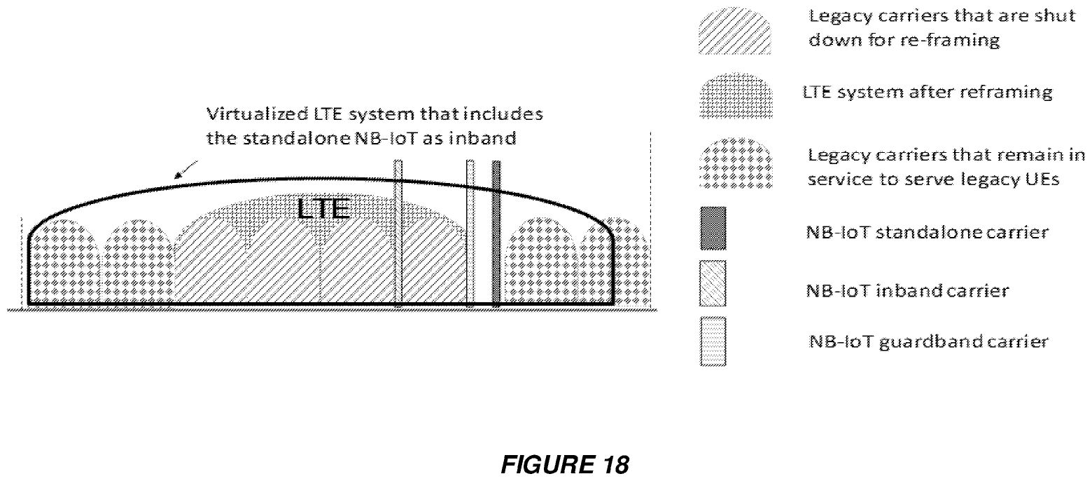

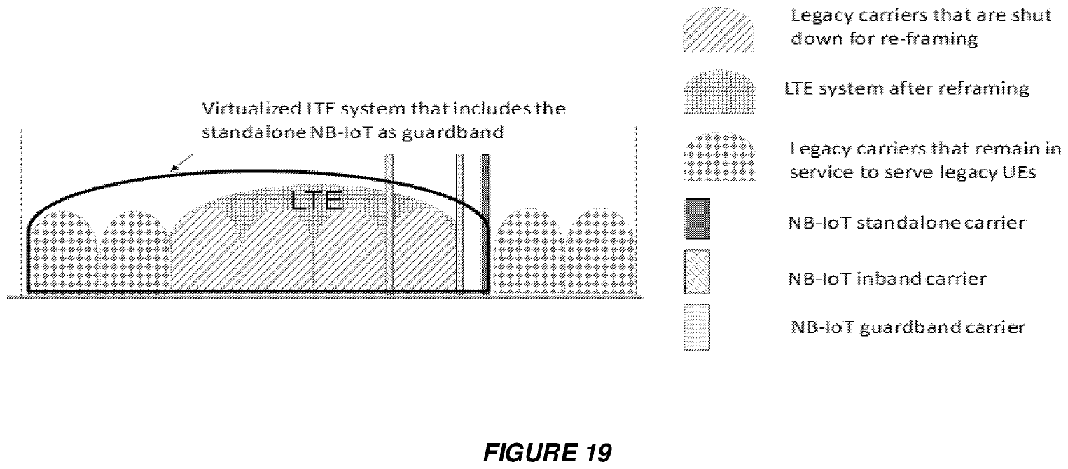

Notice, FIG. 15 and FIG. 16 are just examples. Another example is shown on FIG. 17 that these embodiments can also be used for NB-IoT carriers deployed in-between two legacy carriers. FIGS. 18 and 19 illustrate still other examples where the NB-IoT carrier is deployed between the LTE carrier (outside the guardband of the LTE) and other system, e.g., due to channel raster requirements or inter-system interference issues (legacy systems may not be able to be put too close to the LTE system).

In general, some embodiments can be applied for as long as the NB-IoT carrier can be deployed on a frequency that satisfies the channel raster requirement as well as enough guardband are left between NB-IoT system(s) and legacy systems.

After virtualizing, the NB-IoT carriers outside the LTE bandwidth can work as normal NB-IoT inband or guardband carriers, and they can work as either anchor or secondary NB-IoT carriers. Embodiments herein also apply for both for uplink and downlink.

One or more embodiments herein make standalone NB-IoT carrier to work together with inband or guardband NB-IoT carrier. In some embodiments, this provides more flexible ways for the operators who have fragmented spectrum to deploy NB-IoT system, and ensures the extendibility of the NB-IoT system in the future. Embodiments may also or alternatively provide dynamic UL configurations of an NB-IoT system.

It is noted that a radio node deploying a standalone narrowband carrier may comprise e.g. configuring and/or determining a carrier bandwidth and/or a frequency position of a carrier, wherein a frequency position may be represented by e.g. a center frequency of the carrier. Deploying may additionally and/or optionally comprise informing a wireless device (e.g. a UE) of which UL carrier and/or UL carrier frequency to use for communication in communication system, such as e.g. a narrowband communication system. A radio node informing a wireless device may comprise transmitting a control signal (e.g. RRC) to the wireless device.

It is also mentioned that a wireless device deploying a standalone narrowband carrier may e.g. comprise receiving synchronisation signals transmitted by a radio node. Deploying, by a wireless device may additionally and/or alternatively comprise following instructions transmitted by the radio node. This can e.g. be achieved by the wireless device decoding the control signals transmitted by the radio node and follow the procedures/instructions in the control signals for communication in a narrowband communication system.

### REFERENCES

[1] R4-77AH-IoT-0118, Reply LS on power boosting in-band and guard-band operation for NB-IoT, 3GPP TSG-RAN4 Meeting #77 NB-IOT AH, Budapest, Hungary, 20-22 Jan. 2016.
[2] R1-160082, NB-IoT Channel Raster, source Ericsson, 3GPP TSG-RAN1 NB-IOT Ad Hoc 18-20 Jan. 2016, Budapest, Hungary
[3] R1-160022, Channel raster design, source Huawei, HiSilicon, 3GPP TSG-RAN1 NB-IOT Ad Hoc 18-20 Jan. 2016, Budapest, Hungary
[4] R1-161830, NB-IoT—Synchronization Channel Evaluations, source Ericsson, 3GPP TSG-RAN WG1 NB-IOT AdHoc #2, France, 22-24 Mar. 2016
[5] R1-161958, NB-PSS evaluation, source Huawei, HiSilicon, 3GPP TSG-RAN WG1 NB-IOT AdHoc #2, France, 22-24 Mar. 2016
[6] RP-152284, “New Work Item: Narrowband IoT (NB-IoT),” sources Huawei and HiSilicon, RAN #70.
[7] R1-161548, “RAN1 agreements for Rel-13 NB-IoT”, source WI rapporteur (Ericsson), 3GPP TSG-RAN WG1 Meeting #84, St. Julian's, Malta, Feb. 15-19, 2016.

1-39. (canceled)

40. A method performed by a radio node in a narrowband communication system, the method comprising:
deploying a standalone narrowband carrier for the narrowband communication system outside of an in-band and a guardband of a wideband carrier for a wideband communication system; and
transmitting deployment information to a wireless device indicating that the standalone narrowband carrier is deployed in the in-band or the guardband of the wideband carrier.

41. The method of claim 40:
further comprising deploying one or more other narrowband carriers for the narrowband communication system in the in-band or the guardband of the wideband carrier;
wherein the deploying comprises deploying the standalone narrowband carrier as an anchor carrier and the one or more other narrowband carriers as one or more non-anchor carriers; and
wherein the anchor carrier and the one or more non-anchor carriers are configured for multi-carrier operation, one carrier at a time, by a wireless device.

42. The method of claim 40:
further comprising deploying another narrowband carrier for the narrowband communication system as an anchor carrier in the in-band or the guardband of the wideband carrier and deploying the standalone narrowband carrier as a non-anchor carrier;
wherein the anchor carrier and the non-anchor carrier are configured for multi-carrier operation, one carrier at a time, by a wireless device.

43. A radio node in a narrowband communication system,
processing circuitry;
memory containing instructions executable by the processing circuitry whereby the radio node is operative to:
deploy a standalone narrowband carrier for the narrowband communication system outside of an in-band and a guardband of a wideband carrier for a wideband communication system; and
transmit deployment information to a wireless device indicating that the standalone narrowband carrier is deployed in the in-band or the guardband of the wideband carrier.

44. The radio node of claim 43:
wherein the instructions are such that the radio node is operative to deploy one or more other narrowband carriers for the narrowband communication system in the in-band or the guardband of the wideband carrier;
wherein the deploying comprises deploying the standalone narrowband carrier as an anchor carrier and the one or more other narrowband carriers as one or more non-anchor carriers; and
wherein the anchor carrier and the one or more non-anchor carriers are configured for multi-carrier operation, one carrier at a time, by a wireless device.

45. The radio node of claim 43:
wherein the instructions are such that the radio node is operative to deploy another narrowband carrier for the narrowband communication system as an anchor carrier in the in-band or the guardband of the wideband carrier and deploying the standalone narrowband carrier as a non-anchor carrier; and
wherein the anchor carrier and the non-anchor carrier are configured for multi-carrier operation, one carrier at a time, by a wireless device.

46. A method performed by a wireless device in a narrowband communication system, the method comprising:
receiving deployment information from a radio node indicating that a standalone narrowband carrier for the narrowband communication system is deployed in an in-band or a guardband of a wideband carrier for a wideband communication system.

47. The method of claim 46, further comprising transmitting or receiving on the standalone narrowband carrier outside of the in-band and the guardband of the wideband carrier, in accordance with the received deployment information.

48. The method of claim 46, further comprising searching for the standalone narrowband carrier at frequency positions that satisfy a channel raster condition imposed on a narrowband carrier deployed in the in-band or the guardband of the wideband carrier.

49. The method of claim 46:
wherein one or more other narrowband carriers for the narrowband communication system are deployed in the in-band or the guardband of the wideband carrier;
wherein the standalone narrowband carrier is deployed as an anchor carrier and the one or more other narrowband carriers are deployed as one or more non-anchor carriers; and
wherein the anchor carrier and the one or more non-anchor carriers are configured for multi-carrier operation, one carrier at a time, by the wireless device.

50. The method of claim 46:
wherein another narrowband carrier for the narrowband communication system is deployed as an anchor carrier in the in band or the guardband of the wideband carrier and the standalone narrowband carrier is deployed as a non-anchor carrier; and
wherein the anchor carrier and the non-anchor carrier are configured for multi-carrier operation, one carrier at a time, by the wireless device.

51. A wireless device in a narrowband communication system, the wireless device comprising:
processing circuitry;
memory containing instructions executable by the processing circuitry whereby the wireless device is operative to:
receive deployment information from a radio node indicating that a standalone narrowband carrier for the narrowband communication system is deployed in an in-band or a guardband of a wideband carrier for a wideband communication system.

52. The wireless device of claim 51, wherein the instructions are such that the wireless device is operative to transmit or receive on the standalone narrowband carrier outside of the in-band and the guardband of the wideband carrier, in accordance with the received deployment information.

53. The wireless device of claim 51, wherein the instructions are such that the wireless device is operative to search for the standalone narrowband carrier at frequency positions that satisfy a channel raster condition imposed on a narrowband carrier deployed in the in-band or the guardband of the wideband carrier.

54. The wireless device of claim 51:
wherein one or more other narrowband carriers for the narrowband communication system are deployed in the in-band or the guardband of the wideband carrier;
wherein the standalone narrowband carrier is deployed as an anchor carrier and the one or more other narrowband carriers are deployed as one or more non-anchor carriers; and
wherein the anchor carrier and the one or more non-anchor carriers are configured for multi-carrier operation, one carrier at a time, by the wireless device.

55. The wireless device of claim 51:
wherein another narrowband carrier for the narrowband communication system is deployed as an anchor carrier in the in band or the guardband of the wideband carrier and the standalone narrowband carrier is deployed as a non-anchor carrier; and
wherein the anchor carrier and the non-anchor carrier are configured for multi-carrier operation, one carrier at a time, by the wireless device.
